(19) United States
(12) Patent Application Publication
(10) Pub. No.: US 2020/0167191 A1
(43) Pub. Date: May 28, 2020

(54) LAXITY-AWARE, DYNAMIC PRIORITY VARIATION AT A PROCESSOR

(71) Applicant: ADVANCED MICRO DEVICES, INC., Santa Clara, CA (US)

(72) Inventors: Tsung Tai YEH, Bellevue, WA (US); Bradford BECKMANN, Bellevue, WA (US); Sooraj PUTHOOR, Austin, TX (US); Matthew David SINCLAIR, Bellevue, WA (US)

(21) Appl. No.: 16/200,503

(22) Filed: Nov. 26, 2018

(51) Int. Cl. G06F 9/48

(52) U.S. Cl. CPC G06F 9/4887

(57) ABSTRACT

A processing system includes a task queue, a laxity-aware task scheduler coupled to the task queue, and a workgroup dispatcher coupled to the laxity-aware task scheduler. Based on a laxity evaluation of laxity values associated with a plurality of tasks stored in the task queue, the workgroup dispatcher schedules the plurality of tasks. The laxity evaluation includes determining a priority of each task of the plurality of tasks. The laxity value is determined using laxity information, where the laxity information includes an arrival time, a task duration, a task deadline, and a number of workgroups.

### STATEMENT REGARDING FEDERALLY SPONSORED RESEARCH OR DEVELOPMENT

This invention was made with Government support under PathForward Project with Lawrence Livermore National Security (Prime Contract No. DE-AC52-07NA27344, Subcontract No. B620717) awarded by DOE. The Government has certain rights in this invention.

### BACKGROUND

Many important machine learning computing applications, such as Convolutional Neural Networks (CNNs) and Recurrent Neural Networks (RNNs), have real-time deadlines that must be taken into consideration when scheduling tasks. Tasks may be defined as narrow data-dependent kernels that are typically used in, for example, CNN and RNN applications. Current machine learning systems often use a task priority that is set statically by the programmer or at runtime when a task is enqueued to help inform the hardware how to schedule concurrently submitted tasks. As a result, priority levels are set conservatively to ensure deadlines are met. However, considering priority levels alone is insufficient, as priority levels generally do not give information about when a task must be completed, only the task's relative importance. Furthermore, priority levels assigned to individual tasks do not provide hardware a global view of when a chain of dependent tasks must collectively be completed.

A task scheduling solution that has been deployed to meet real-time deadlines on central processing units (CPUs) and graphic processing units (GPUs) is pre-empting lower priority tasks in order to execute higher priority tasks. This pre-emption technique is often used by multi-core CPUs and sparingly used by GPUs. Most pre-emption schemes are guided by the operating system and often decrease overall throughput due to the overhead of preemption. Preemption overhead is particularly problematic on GPUs due to the GPUs high amount of context state. Furthermore, the latency of communicating between the OS and an accelerator make immediate changes difficult.

Another task scheduling solution that has been deployed to meet real-time deadlines is to execute tasks from multiple queues concurrently and associate unique priorities to tasks from different queues. For example, some GPUs support four priority levels (Graphics, High, Medium, Low) that help convey information about a task's real-time constraints to the scheduler. However, since the information provided by higher level software is static and only associated with the individual task, the scheduler cannot determine how the priority relates to the current global situation of the GPU.

Other solutions have used persistent threads or kernels along with a low-level user runtime to handle concurrent tasks. The persistent kernel technique has become particularly popular for current RNN inference applications. While persistent kernels perform adequately when the task runtimes are well understood and the available hardware resources remain constant, persistent kernels break down when task runtimes and hardware resources dynamically change. Thus, an improved task scheduling technique that improves latency and utilizes dynamic scheduling applications is desirable.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system implementing laxity-aware task scheduling in accordance with some embodiments.

FIG. 2 is a block diagram of a graphics processing unit implementing laxity-aware task scheduling in accordance with some embodiments.

FIG. 3 is a block diagram of a laxity-aware task scheduler with tables and a queue used in implementing laxity-aware task scheduling in accordance with some embodiments.

FIG. 4 is a block diagram of an example operation of a laxity-aware task scheduler in accordance with some embodiments.

FIG. 5 is a block diagram of an example operation of a laxity-aware task scheduler in accordance with some embodiments.

FIG. 6 is a flow diagram illustrating a method for performing laxity-aware task scheduling utilizing at least a portion of a component of a processing system in accordance with some embodiments.

### DETAILED DESCRIPTION

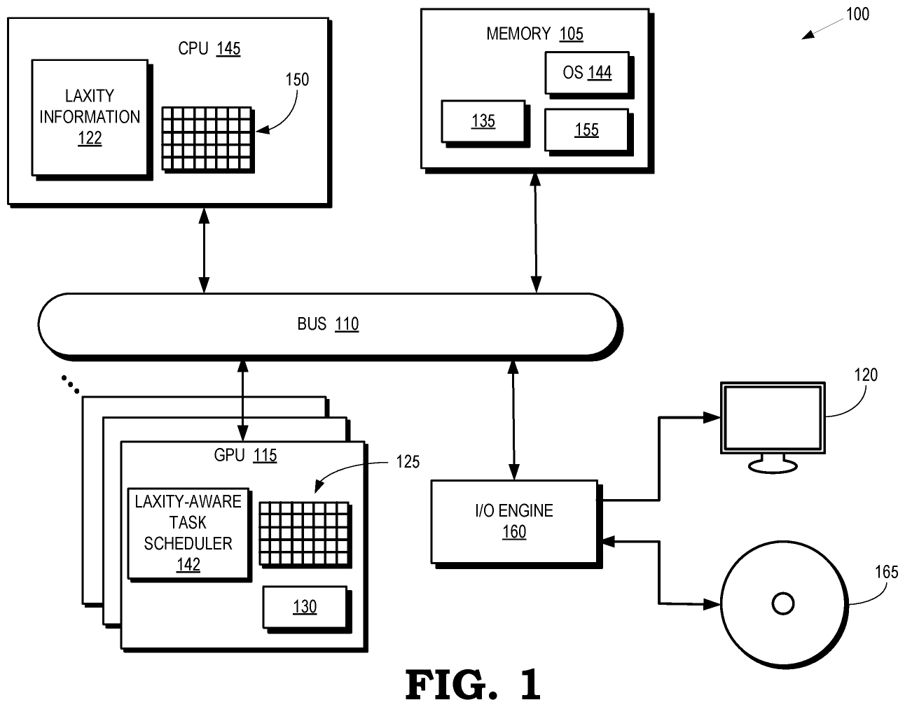

With reference to FIGS. 1-6, a laxity-aware task scheduling system prioritizes tasks and/or jobs, including the time to switch the priority of tasks associated with a job, based upon, for example, the laxity calculated for the tasks provided by the central processing unit (CPU) or memory to the graphics processing unit (GPU). The laxity-aware task scheduling system mitigates scheduling issues by enhancing the task scheduler to dynamically change a task's priority based on the deadline associated with the job.

Improvements and benefits of the laxity-aware task scheduling system over other task-schedulers includes the ability of the laxity-aware task scheduling system to allow many Recurrent Neural Network (RNN) inference jobs running on a GPU to be scheduled concurrently. The term job in this case refers to a set of dependent tasks (e.g., GPU kernels) that are to be completed on time in order to meet real-time deadlines. The ability of the laxity-aware scheduling system to manage significant real-time constraints gives the laxity-aware scheduling system the capability to handle many important scheduling problems that occur in machine translation, speech recognition, object tracking on self-driving cars, and speech translation. A single RNN inference job typically contains a series of narrow data-dependent kernels (i.e., tasks) that often times, without the proper scheduling approach, do not fully utilize the processing capability of the GPU. However, using the laxity-aware task scheduling system allows many independent RNN inference jobs to be scheduled concurrently in order to improve scheduling efficiency and meet the real-time deadlines.

Other scheduling techniques used for executing concurrent RNN inference jobs where the tasks associated with each individual RNN job are enqueued in separate queues, include, for example, First-In-First-Out (FIFO) job schedulers. FIFO job schedulers always attempt to execute individual jobs in a FIFO manner and statically partition GPU resources across jobs or batch multiple jobs together, which causes an increase in response time and reduced throughput, risking the real-time guarantee of the scheduling system. The laxity-aware tasking system batches jobs together and improves average response time by, for example, 4.5 times over the FIFO scheduling of individual jobs. Thus, the laxity-aware scheduling system improves GPU performance significantly over other FIFO scheduling techniques.

FIG. 1 is a block diagram of a processing system 100 implementing laxity-aware task scheduling in accordance with some embodiments. Processing system 100 includes a central processing unit (CPU) 145, a memory 105, a bus 110, graphics processing units (GPUs) 115, an input/output engine 160, a display 120, and an external storage component 165. GPU 115 includes a laxity-aware task scheduler 142, compute units 125, and internal (or on-chip) memory 130. CPU 145 includes processor cores 150 and laxity information 122. Memory 105 includes a copy of instructions 135, operating system 144, and program code 155. In various embodiments, CPU 145 is coupled to GPUs 115, memory 105, and I/O engine 160 via bus 110.

Processing system 100 has access to memory 105 or other storage component that is implemented using a non-transitory computer readable medium such as a dynamic random access memory (DRAM). However, memory 105 can also be implemented using other types of memory including static random access memory (SRAM), nonvolatile RAM, and the like.

Processing system 100 also includes bus 110 to support communication between entities implemented in processing system 100, such as memory 105. Some embodiments of processing system 100 include other buses, bridges, switches, routers, and the like, which are not shown in FIG. 1 in the interest of clarity.

Processing system 100 includes one or more GPUs 115 that are configured to perform machine learning tasks and render images for presentation on display 120. For example, GPU 115 can render objects to produce values of pixels that are provided to display 120, which uses the pixel values to display an image that represents the rendered objects. Some embodiments of GPU 115 can also be used for high-end computing. For example, GPU 115 can be used to implement machine learning algorithms for various types of neural networks, such as, for example, convolutional neural networks (CNNs) or recurrent neural networks (RNNs). In some cases, operation of multiple GPUs 115 are coordinated to execute the machine learning algorithms when, for example, a single GPU 115 does not possess enough processing power to execute the assigned machine learning algorithms. The multiple GPUs 115 communicate using inter-GPU communication over one or more interfaces (not shown in FIG. 1 in the interest of clarity).

Processing system 100 includes input/output (I/O) engine 160 that handles input or output operations associated with display 120, as well as other elements of processing system 100 such as keyboards, mice, printers, external disks, and the like. I/O engine 160 is coupled to the bus 110 so that I/O engine 160 communicates with memory 105, GPU 115, or CPU 145. In the illustrated embodiment, I/O engine 160 is configured to read information stored on an external storage component 165, which is implemented using a non-transitory computer readable medium such as a compact disk (CD), a digital video disc (DVD), and the like. I/O engine 160 can also write information to the external storage component 165, such as the results of processing by GPU 115 or CPU 145.

Processing system 100 also includes CPU 145 that is connected to bus 110 and communicates with GPU 115 and memory 105 via bus 110. In the illustrated embodiment, CPU 145 implements multiple processing elements (also referred to as processor cores) 150 that are configured to execute instructions concurrently or in parallel. CPU 145 can execute instructions such as program code 155 stored in memory 105 and CPU 145 can store information in memory 105 such as the results of the executed instructions. CPU 145 is also able to initiate graphics processing by issuing draw calls, i.e., commands or instructions, to GPU 115.

GPU 115 implements multiple processing elements (also referred to as compute units) 125 that are configured to execute instructions concurrently or in parallel. GPU 115 also includes internal memory 130 that includes a local data store (LDS), as well as caches, registers, or buffers utilized by the compute units 125. Internal memory 130 stores data structures that describe tasks executing on one or more of the compute units 125.

In the illustrated embodiment, GPU 115 communicates with memory 105 over the bus 110. However, some embodiments of GPU 115 communicate with memory 105 over a direct connection or via other buses, bridges, switches, routers, and the like. GPU 115 can execute instructions stored in memory 105 and GPU 115 can store information in memory 105 such as the results of the executed instructions. For example, memory 105 can store a copy of instructions 135 from program code that is to be executed by GPU 115, such as program code that represents a machine learning algorithm or neural network. GPU 115 also includes coprocessor 140 that receives task requests and dispatches tasks to one or more of the compute units 125.

During operation of processing system 100, CPU 145 issues commands or instructions to GPU 115 to initiate processing of a kernel that represents the program instructions that are executed by GPU 115. Multiple instances of the kernel, referred to herein as threads or work items, are executed concurrently or in parallel using subsets of compute units 125. In some embodiments, the threads execute according to single-instruction-multiple-data (SIMD) protocols so that each thread executes the same instruction on different data. The threads are collected into workgroups that are executed on different compute units 125.

At least in part to address the problems associated with conventional task scheduling practice, and in order to improve utilization, performance, and meet real-time deadlines of a series of data-dependent tasks, laxity-aware task scheduler 142 is enhanced to dynamically adjust task priority based on the laxity of a job or task's deadline. As used herein, laxity is the amount of extra-time or slack a task has before the task must be completed. In some embodiments, a task's (or job's) dynamic priority is set based on the difference between the task's (or job's) real-time deadline that is provided from software (or calculated from, for example, laxity information provided from CPU 145) and the estimated amount of time the collection of remaining tasks associated with the job will take to complete. The estimation is based on, for example, the time consumed by similar tasks that have previously occurred and is stored in, for example, a hardware table by laxity-aware task scheduler 142. In various embodiments, the estimation is determined by, for example, a packet processor (e.g., GPU 115) analyzing the remaining tasks in the associated job's queue. Once the packet processor determines the type of tasks that remain, the packet processor references the hardware table that stores the duration of previous tasks. By summing up the estimates, laxity aware task scheduler 142 estimates the time remaining. As the task's laxity decreases, the priority of the task increases. Moreover, to continually improve the accuracy of subsequent estimates, the information stored in the hardware table is updated after a task completes and is further refined to include the amount of resources dedicated to that task.

In various embodiments, laxity-aware task scheduler 142 of processing system 100 provides a mechanism for task scheduling that augments an existing scheduling policy, such as, for example, the Earliest Deadline First (EDF) task scheduling algorithm, by dynamically varying the task priority of compute tasks based on the amount of laxity of a task or job prior to completion. In various embodiments, before the task deadline or job deadline must be completed, when a job or task has laxity then the priority of the tasks with laxity can be reduced in the scheduling queue to allow other tasks to complete.

In various embodiments, to enable GPU 115 to dynamically adjust tasks to account for laxity, hardware and software, such as, for example, laxity-aware task scheduler 142 and laxity-information 122, are provided as support to GPU 115, while also informing GPU 115 of the job's real-time deadline, provide estimates of the duration of a given task or job to completion, e.g., the time required for a task or job to complete based on prior runs of the same task (or other tasks with similar kernels), and update the estimates after a task has completed.

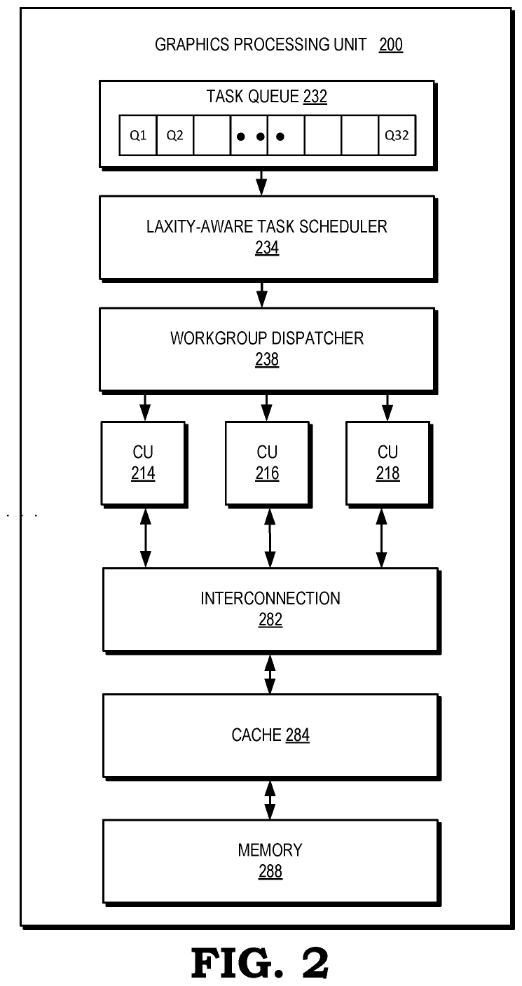

FIG. 2 illustrates a graphics processing unit (GPU) 200 implementing laxity-aware task scheduling in accordance with some embodiments. GPU 200 includes a task queue 234, a laxity-aware task scheduler 234, a workgroup dispatcher 238, a compute unit 214, a compute unit 216, a compute unit 218, an interconnection 282, a cache 284, and a memory 288. Task queue 234 is coupled to laxity-aware task scheduler 234. Laxity-aware task scheduler 234 is coupled to workgroup dispatcher 238. Workgroup dispatcher 238 is coupled to compute units 214-216. Compute units 214-216 are coupled to interconnection 282. Interconnection 282 is coupled to cache 284. Cache 284 is coupled to memory 288. In various embodiments, other types of processing units may be utilized for laxity-aware task scheduling implementation, such as, for example, a CPU.

During operation of GPU 200, with further reference to FIG. 1, CPU 145 dispatches work to GPU 200 by sending packets such as Architected Queuing Language (AQL) packets that describe a kernel that is to be executed on GPU 200. Some embodiments of the packets include an address of code to be executed on GPU 200, register allocation requirements, a size of a Local Data Store (LDS), workgroup sizes, configuration information defining an initial register state, pointers to argument buffers, and the like. The packet is enqueued by writing the packet to a task queue 234 such as, for example, an AQL queue.

In various embodiments, GPU 200 of processing system 100 may use Heterogeneous Interface for Portability (HIP) Streams to asynchronously launch the kernels. The kernels launched by a HIP stream are mapped to task queue 234 (the AQL queue). In various embodiments, each RNN job uses a separate HIP stream and workgroup dispatcher 238 scans through each AQL queue to find the tasks associated with the job (e.g., Q1, Q2, . . . , Q32). Workgroup dispatcher 238 schedules the work in these queues in a round-robin fashion. Kernels handled by different HIP streams or AQL queues (which represent different RNN jobs) can be executed simultaneously as long as hardware resources, such as workgroup, registers and LDS, are available. Thus, kernels of different RNN jobs can be executed concurrently on a plurality of GPUs 200. In various embodiments, the scheduling policy of workgroup dispatcher 238 is reconfigured or changed to a laxity-aware scheduling policy to facilitate the response time of RNN tasks.

During operation of processing system 100, GPU 200 receives a plurality of jobs (e.g., RNN jobs) to execute from CPU 145. In various embodiments, a job includes a plurality of tasks that have a real time constraint to be met by GPU 200. Each task may have an associated slack or laxity that is defined as the difference between the time remaining before a job's real-time deadline (task deadline or job deadline) and the amount of time required to complete the task or job (task duration or job duration). In both instances, the job deadline or task deadline may be provided by, for example, OS 144 or CPU 145.

GPU 200 receives the jobs and stores the jobs and the tasks associated with each job in task queue 234. In order to perform laxity-aware task scheduling, each task stored in task queue 234 includes laxity information specific to each job and task. In various embodiments, the laxity information includes, for example, job arrival time, job deadline, and the number of workgroups. In various embodiments, the laxity information includes, for example, task arrival time, task deadline, and the number of workgroups. In various embodiments, the laxity information may also include a job duration and/or task duration provided by laxity information module 122 and/or OS 144.

Laxity-aware task scheduler 234 receives the laxity information and task duration and determines the laxity, if any, associated with each task. In various embodiments, as stated above, laxity-aware task scheduler 234 determines the laxity associated with a task by subtracting the duration of a task from the job deadline for the task. For example, if a task has a job deadline time step (i.e., an increment of time) of seven, the task duration has a time step of four and it is the last task in the job's queue, then the laxity associated with the task is three. Laxity-aware task scheduler 234 continues to compute laxity values for each task associated with a job and provides the task laxity values to workgroup dispatcher 238 for task priority assignment.

In various embodiments, workgroup dispatcher 238 receives the laxity values associated with each task from laxity-aware task scheduler 234 and assigns a priority for each task based on the laxity values of all tasks. Workgroup dispatcher 238 assigns a priority by comparing the laxity values of each task to the laxity values of other tasks. Workgroup dispatcher 238 dynamically increases or decreases the priority of each task based on the results of the comparison. For example, tasks with lower laxity values compared to the laxity values of other tasks receive a higher scheduling priority. Tasks with higher laxity values compared to other laxity values of other tasks receive a lower scheduling priority. The tasks with a higher scheduling priority are scheduled for execution before tasks with a lower scheduling priority. The tasks with a lower scheduling priority are scheduled for execution after tasks with a higher scheduling priority.

In various embodiments, workgroup dispatcher 238 uses a workgroup scheduler (not shown) to select workgroups from the newly updated highest priority tasks to the lower priority tasks until compute units 214-216 do not have additional slots available for additional tasks. Compute units 214-216 execute the tasks in the given priority and provide the executed tasks to interconnection 282 for further distribution to cache 284 and memory 288 for processing.

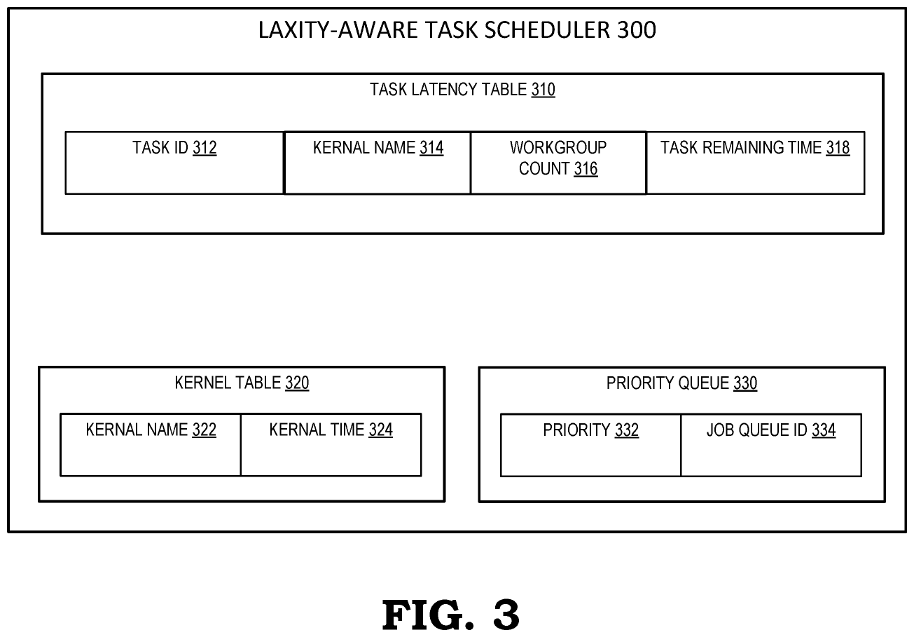

FIG. 3 is a block diagram of a laxity-aware task scheduler 300 implementing laxity-aware task scheduling in accordance with some embodiments. Laxity-aware task scheduler 300 includes a task latency table 310, a kernel table 320, and a priority queue 330. Task latency table 310 includes a Task Identification (Task ID) 312, Kernel Name 314, Workgroup Count 316, and Task Remaining Time 318. Task ID 312 stores the identification number of the task. In various embodiments, the TASK ID is identical to an AQL queue ID provided by, for example, CPU 145. Kernel Name 314 stores the name of the kernel. Workgroup Count stores the number of kernels used by a task within a job.

Task Remaining Time 318 is the time remaining in a task and is determined by multiplying the workgroup execution time, i.e., Kernel Time 324, in the kernel table 320 with the workgroup count entry, i.e., Workgroup Count 316, of task latency table 310. Task Remaining Time stores the result of the multiplication of the single work execution time from Kernel Table 320 and the workgroup count entry from Kernel Name-Workgroup Count of Task Latency Table 310.

Kernel table 320 stores a Kernel Name 322 and a Kernel Time 324. Kernel Name 322 is the name of the kernel being executed and Kernel Time 324 is the average execution time of the kernel's workgroups. Priority queue table 330 includes a Task Priority 332 and a Task Queue ID 334. The Task Priority 332 is the priority that a task is being assigned by laxity-task scheduler 300. The Task Queue ID 334 is the ID number of the task in the queue. In various embodiments, a job may be interchanged with a task in laxity-aware task scheduler 300 to enable laxity-aware job scheduling for GPU 200 of processing system 100.

Laxity-aware task scheduler 300, with reference to FIGS. 1-3, uses the values stored in Task Latency Table 310 and Kernel Table 320, along with laxity information passed by, for example, OS 144, or by runtime, or set by a user from an application, for laxity and task priority assessment, i.e., laxity-aware task scheduling. The laxity information includes, for example, job arrival time, task duration, job deadline, and the number of workgroups. The job arrival time is the time at which a job arrives at, for example, GPU 200. The job deadline is the time at which a job must be completed and is dictated by processing system 100. The task duration is the estimated length of a task.

The task duration can either be provided to laxity-aware task scheduler 300 by OS 144 or laxity-aware task scheduler 300 can estimate the task duration by using task latency table 310 and kernel table 320. In various embodiments, laxity-aware task scheduler 300 estimates the task duration by subtracting the task arrival time from the current task time.

The entries in task latency table 310, kernel table 320, and priority queue table 330 are updated upon completion of a kernel by processing system 100. When processing system 100 completes a kernel, the corresponding entries in kernel table 320 and task latency table 310 are updated to determine subsequent task duration estimates. Using the information provided in task latency table 310, kernel table 320, and priority queue table 330, the laxity of a task is calculated when all tasks associated with the job/queue are known.

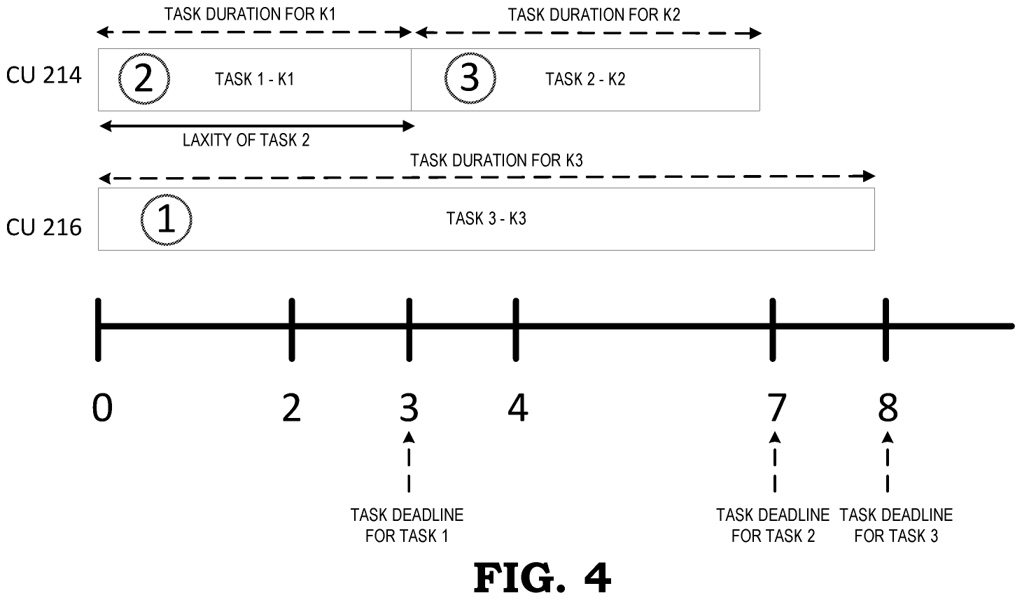

FIG. 4 is an illustration of laxity-aware task scheduling in accordance with some embodiments. With reference to FIGS. 1-3, for the illustrated example, there are three tasks, TASK 1, TASK 2, and TASK 3, that were received by laxity-aware task scheduler 300 from task queue 234. Each task contains a single kernel and the kernels and tasks are numbered 1-3 (i.e., TASK 1, TASK 2, and TASK 3) to represent the order that each task arrived. In the example depicted in FIG. 4, TASK 1 arrived first, TASK 2 arrived second, and TASK 3 arrived third. At arrival time, GPU 200 assumes that all three kernels have the same (static) priority. For the example illustrated in FIG. 4, there are two compute units, CU 214 and CU 216, available for scheduling by laxity-aware task scheduler 300. The horizontal axis is indicative of timesteps 0-8, which provide, for example, an indication of the task deadlines for each task, as well as the task duration and laxity values.

The laxity information provided from, for example, CPU 145 or OS 144, for each task (TASK 1, TASK 2, and TASK 3) is of the form K(arrival time, task duration, job deadline, number of workgroups). For TASK 1, K1(arrival time, task duration, job deadline, number of workgroups) is K1(0, 3, 3, 1). For TASK 2, K2(arrival time, task duration, job deadline, number of workgroups) is K2(0, 4, 7, 1). For TASK 3, K(arrival time, task duration, job deadline, number of workgroups) is K3(0, 8, 8, 1). Thus, for K1, the arrival time, task duration, task deadline, and number of workgroups are 0, 3, 3, and 1, respectively. For K2, the arrival time, task duration, task deadline, and number of workgroups are 0, 4, 7 and 1, respectively. For K3, the arrival time, task duration, task deadline, and number of workgroups are 0, 8, 8, and 1, respectively.

In various embodiments, using the arrival time, task duration, job deadline, and number of workgroups of each task, the laxity values for each task are calculated for scheduling purposes. For TASK 1, the laxity value is calculated as 3-3, which is 0. For TASK 2, the laxity value is calculated as 7-4, which is 3. For TASK 3, the laxity value is calculated as 8-8, which is 0. The tasks are then scheduled, as can be seen from the circled numbers 1, 2, and 3, based on a comparison of the laxity values for each task. TASK 3 and TASK 1 have the lowest laxity values amongst the three tasks, each with a laxity value of 0. Because the laxity values of TASK 1 and TASK 3 are equal, the task duration of TASK 1 and the task duration of TASK 3 are compared to ascertain which task has the lowest task duration amongst the tasks. The task with the greatest (maximum) task duration is scheduled first and the task with the second greatest task duration is scheduled second, and so on. For the example provided, the task duration of TASK 3 is greater than the task duration of TASK 1, thus TASK 3 is scheduled first in compute unit 216. TASK 1 is scheduled second in compute unit 214. TASK 2 is scheduled third in compute unit 214. Thus laxity-aware task scheduler 300 has scheduled TASK 1, TASK 2, and TASK 3 based on the laxity of each task.

In various embodiments, when, for example, TASK 3 is scheduled before TASK 2 on compute unit 216, then TASK 1 and TASK 2 can utilize compute unit 214 sequentially, taking advantage of the laxity of TASK 2, while TASK 3 meets its task deadline by using compute unit 216. Task scheduler 334 has dynamically adjusted the scheduled tasks such task TASK 1 and TASK 3 are executed by CU 214 within the eight timesteps, and task TASK 2 is executed by CU 216. Thus, using the laxity-aware task scheduler 300 has enabled GPU 200 to execute tasks TASK 1, TASK 2, and TASK 3 within the eight timestep deadline. Scheduling the tasks using laxity-aware task scheduling allows the use of compute unit 214 and compute unit 216 to be maximized while allowing dynamically increasing the priority of tasks with the lowest laxity values.

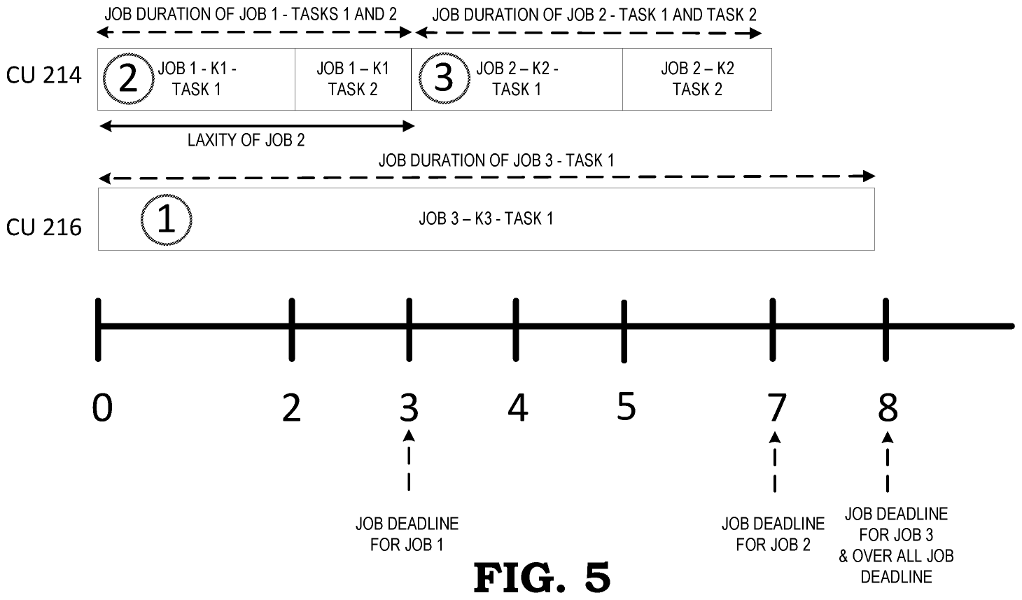

FIG. 5 is an illustration of laxity-aware task scheduling in accordance with some embodiments. FIG. 5 depicts an example of the laxity-aware task scheduling of jobs with multiple tasks, i.e., where each job has at least one task. With reference to FIGS. 1-3, for the illustrated example, there are three jobs, JOB 1, JOB 2, and JOB 3, that were received by laxity-aware task scheduler 300 from task queue 234. In some embodiments, for each job that has more than one task, i.e., a plurality of tasks, the task sequence is dependent on the ordering of the task, i.e., the tasks for each job can execute in a prespecified order, similar to a task graph. That is, for example, TASK 1 of JOB 1 must be completed before TASK 2 of JOB 1. TASK 1 of JOB 2 must be completed before TASK 2 of JOB 2. Each job contains a single kernel and the kernels and the jobs are numbered 1-3 (i.e., JOB 1, JOB 2, and JOB 3) to represent the order that each job arrived. In the example depicted in FIG. 5, JOB 1 arrived first, JOB 2 arrived second, and JOB 3 arrived third. At arrival time, GPU 200 assumes that all three kernels have the same (static) priority. For the example illustrated in FIG. 5, there are two compute units, CU 214 and CU 216, available for scheduling by laxity-aware task scheduler 300.

The laxity information provided from, for example, CPU 145 or OS 144, for each job (JOB 1, JOB 2, and JOB 3) is of the form K(arrival time, job duration, job deadline, number of workgroups). For JOB 1, K1(arrival time, job duration, job deadline, number of workgroups) is K1(0, 3, 3, 1). For JOB 2, K2(arrival time, job duration, job deadline, number of workgroups) is K2(0, 4, 7, 1). For JOB 3, K(arrival time, job duration, job deadline, number of workgroups) is K3(0, 8, 8, 1). Thus, for K1, the arrival time, job duration, job deadline, and number of workgroups are 0, 3, 3, and 1, respectively. For K2, the arrival time, job duration, job deadline, and number of workgroups are 0, 4, 7 and 1, respectively. For K3, the arrival time, job duration, job deadline, and number of workgroups are 0, 8, 8, and 1, respectively.

In various embodiments, using the arrival time, job duration, job deadline, and number of workgroups of each job, the laxity values for each job are calculated for scheduling purposes. For JOB 1, the laxity value is calculated as 3-3, which is 0. For JOB 2, the laxity value is calculated as 7-4, which is 3. For JOB 3, the laxity value is calculated as 8-8, which is 0. The jobs are then scheduled, as can be seen from the circled numbers 1, 2, and 3, based on a comparison of the laxity values for each job. JOB 3 and JOB 1 have the lowest laxity values amongst the three jobs, each with a laxity value of 0. Because the laxity values of JOB 1 and JOB 3 are equal, the job duration of JOB 1 and the job duration of JOB 3 are compared to ascertain which job has the lowest job duration amongst the jobs. The job with the greatest (maximum) job duration is scheduled first and the job with the second greatest job duration is scheduled second, and so on. For the example provided, the job duration of JOB 3 is greater than the job duration of JOB 1, thus JOB 3 is scheduled first in compute unit 216. JOB 1 is scheduled second in compute unit 214. JOB 2 is scheduled third in compute unit 214. Thus laxity-aware task scheduler 300 has scheduled JOB 1, JOB 2, and JOB 3 and their corresponding tasks based on the laxity of each job.

In various embodiments, when, for example, JOB 3 is scheduled before JOB 2 on compute unit 216, then JOB 1 and JOB 2 can utilize compute unit 214 sequentially, taking advantage of the laxity of JOB 2, while JOB 3 meets its job deadline by using compute unit 216. Task scheduler 334 has dynamically adjusted the scheduled jobs such that JOB 1 and JOB 3 are executed by CU 214 within the eight timesteps, and JOB 2 is executed by CU 216. Thus, using the laxity-aware task scheduler 300 has enabled GPU 200 to execute jobs JOB 1, JOB 2, and JOB 3 within the eight timestep deadline. Scheduling the jobs using laxity-aware task scheduling allows the use of compute unit 214 and compute unit 216 to be maximized while allowing dynamically increasing the priority of jobs with the lowest laxity values.

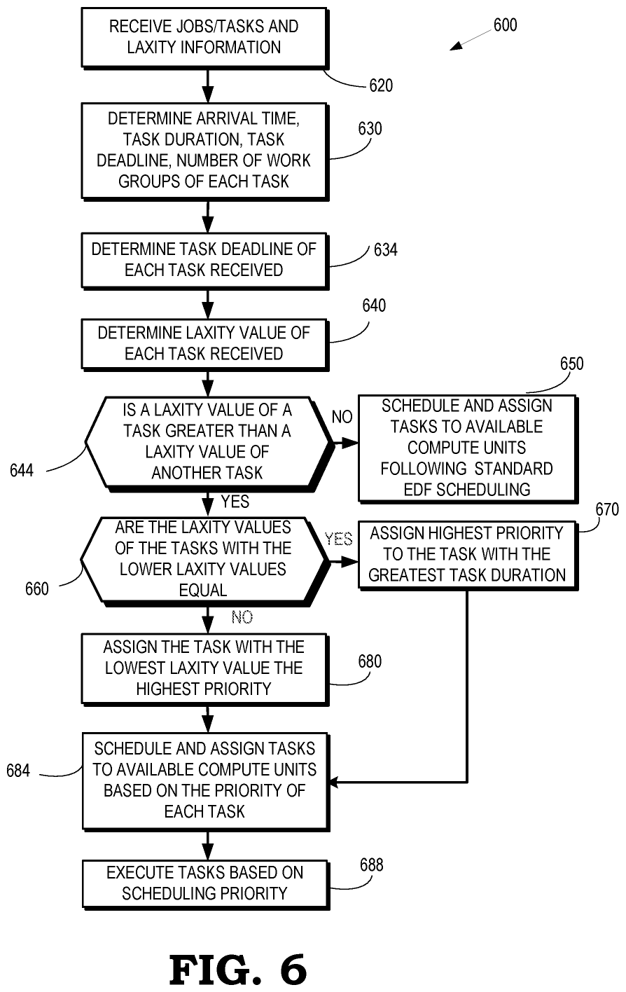

FIG. 6 is a flow diagram illustrating a method 600 for performing laxity-aware task scheduling in accordance with some embodiments. The method 600 is implemented in some embodiments of processing system 100 shown in FIG. 1, GPU 200 shown in FIG. 2, and laxity-aware task scheduler 300 shown in FIG. 3.

In various embodiments, the method flow begins with block 620. At block 620, laxity-aware task scheduler 234 receives jobs and laxity information from, for example, CPU 145. At block 630, laxity-aware task scheduler 234 determines the arrival time, task duration, task deadline, and number of workgroups of each task.

At block 634, laxity-aware task scheduler 234 determines the task deadline of each received task. At block 640, laxity-aware task scheduler 234 determines the laxity values of each task received.

At block 644, workgroup dispatcher 238 determines whether a laxity value of a task is greater than a laxity value of other tasks in a job received by GPU 200. At block 650, when a laxity value of a task is not greater than a laxity value of other tasks in a job, workgroup dispatcher 238 schedules and assigns the tasks to available compute units 214-216 of GPU 200 following standard EDF techniques.

At block 660, when a laxity value of a task is greater than a laxity value of other tasks in a job, workgroup dispatcher 238 determines whether the laxity values of the tasks with the lower laxity values are equal. At block 670, when the laxity values of the tasks with the lower laxity values are equal, workgroup dispatcher 238 assigns the highest priority to the task with the greatest task duration.

At block 680, when the laxity values of the tasks with the lower laxity values are not equal, workgroup dispatcher 238 assigns the task with the lowest laxity value the highest priority.

At block 684, workgroup dispatcher 238 schedules and assigns the tasks to available compute units 214-216 of GPU 200 based on the priority of each task, with the highest priority task being scheduled first. At block 688, GPU 200 executes the tasks based on the laxity-aware scheduling priority.

In some embodiments, the apparatus and techniques described above are implemented in a system including one or more integrated circuit (IC) devices (also referred to as integrated circuit packages or microchips), such as the processing system described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method, comprising:
receiving laxity information associated with each task of a plurality of tasks;
determining a laxity value for each task of said plurality of tasks based on said laxity information;
performing a laxity evaluation of said laxity values; and
scheduling said plurality of tasks based on said laxity evaluation.

2. The method of claim 1, wherein:
said laxity evaluation includes determining a priority of each task of said plurality of tasks.

3. The method of claim 2, wherein:
said laxity information is used to determine an amount of time for completion of each task and includes an arrival time, a task duration, a task deadline, and a number of workgroups.

4. The method of claim 3, wherein:
said priority of each task of said plurality of tasks is determined by comparing said laxity value of each task of said plurality of tasks.

5. The method of claim 4, further comprising:
determining said laxity value by subtracting said task duration from said task deadline.

6. The method of claim 4, wherein scheduling includes:
when a first laxity value associated with a first task of said plurality of tasks is less than a second laxity value associated with a second task of said plurality of tasks, said first task receives scheduling priority over said second task.

7. The method of claim 4, further comprising:
wherein scheduling said plurality of tasks includes providing a first task of said plurality of tasks with a higher priority level to a first compute unit prior to providing a second task of said plurality of tasks with a lower priority level to said first compute unit.

8. The method of claim 4, wherein:
when a first task duration of a first task with higher priority is less than or equal to a laxity value of a second task of lower priority then said first task, said first task is scheduled prior to said second task in a first compute unit.

9. The method of claim 4, further comprising:
assigning said plurality of tasks to at least a first compute unit and a second compute unit based on said priority of each task.

10. A processing system, comprising:
a task queue;
a laxity-aware task scheduler coupled to said task queue; and
a workgroup dispatcher coupled to said laxity-aware task scheduler, wherein based on a laxity evaluation of laxity values associated with a plurality of tasks stored in said task queue, said workgroup dispatcher schedules said plurality of tasks.

11. The processing system of claim 10, wherein:
said laxity evaluation includes determining a priority of each task of said plurality of tasks.

12. The processing system of claim 11, wherein:
said laxity value is determined using laxity information, said laxity information including an arrival time, a task duration, a task deadline, and a number of workgroups.

13. The processing system of claim 12, wherein:
said priority of each task of said plurality of tasks is determined by comparing the laxity values of each task of said plurality of tasks.

14. The processing system of claim 12, wherein:
said laxity value is determined by subtracting said task duration from said task deadline.

15. The processing system of claim 10, wherein:
when a first laxity value of said laxity values associated with a first task of said plurality of tasks is less than a second laxity value of said laxity values associated with a second task of said plurality of tasks, said first task receives scheduling priority over said second task.

16. The processing system of claim 15, wherein:
said workgroup dispatcher schedules said plurality of tasks by providing a first task of said plurality of tasks with a higher priority level to a first compute unit prior to providing a second task of said plurality of tasks with a lower priority level to said first compute unit.

17. The processing system of claim 16, wherein:
when a first task duration of a first task with higher priority is less than or equal to a laxity value of a second task of lower priority, said first task is scheduled prior to said second task in a first compute unit.

18. A method, comprising:
providing a plurality of jobs to a laxity-aware task scheduler, wherein said plurality of jobs includes a first job and a second job;
determining a first laxity value of said first job and a second laxity value of said second job; and
assigning a first priority to said first job and a second priority to said second job based on a laxity evaluation of said first laxity value and said second laxity value.

19. The method of claim 18, further comprising:
scheduling said first job and said second job based on said laxity evaluation.

20. The method of claim 18, further comprising:
adjusting said first priority of said first job and said second priority of said second job based on said laxity evaluation.
